(19) United States
(12) Patent Application Publication
(10) Pub. No.: US 2012/0254405 A1
(43) Pub. Date: Oct. 4, 2012

(54) SYSTEM AND METHOD FOR BENCHMARKING WEB ACCESSIBILITY FEATURES IN WEBSITES

(75) Inventors: Jai Ganesh, Bangalore (IN); Ajay Kolhatkar, Pune (IN)

(73) Assignee: INFOSYS TECHNOLOGIES LIMITED, Bangalore (IN)

(21) Appl. No.: 13/111,347

(22) Filed: May 19, 2011

(30) Foreign Application Priority Data
Mar. 31, 2011 (IN) 1058/CHE/2011

(51) Int. Cl. G06F 15/173

(52) U.S. Cl. 709/224

(57) ABSTRACT

The disclosed embodiment relates to a system and method for rating the accessibility of websites to disabled users. The method comprises receiving, with a computing device, ratings information from at least one user, the ratings information including ratings values of at least one website based on at least one web accessibility parameter, determining, with a computing device, a web accessibility score for at least one of the websites, wherein the web accessibility score is based on the ratings information received from the at least one user, and creating, with a computing device, a web accessibility index including the web accessibility score of at least one of the websites based on the determined web accessibility score. The disclosed embodiment also relates to a system and computer-readable code that can be used to implement the exemplary methods.

### RELATED APPLICATION DATA

This application claims priority to Indian Patent Application No. 1058/CHE/2011, filed Mar. 31, 2011, which is hereby incorporated by reference in its entirety.

### FIELD OF THE INVENTION

The invention relates to a system and method for rating the accessibility of websites to disabled users.

### BACKGROUND

With advances in technology, information has become accessible via various resources. Papers have now been replaced with electronic documents that can be accessed using websites on the Internet or the World Wide Web. However, websites need to serve users regardless of their physical and psychological backgrounds. People who are disabled or differently-abled should be able to access information on the Internet without any difficulties. Web accessibility is the practice of developing websites that are easily accessible by people of different abilities or by people having disabilities.

People with disabilities include people having blindness, deaf or hard of hearing users, low-vision users, color blind users, users with motor disability impairing use of a keyboard or mouse, and users with cognitive disabilities. Challenges faced by disabled people include, inability of visually challenged users to read images, inability of hearing impaired users to access audio, inability of monochrome device users to differentiate between colors, and inability of old people to read small font text. Further, since a lot of Internet use nowadays relate to access and utilization of entertainment content, websites are generally designed using audio, video and colorful content including the use of images. For visually challenged users, screen reader softwares which read and interpret text on a screen cannot read images and this causes lot of inconveniences to users of screen reader softwares. Users having cognitive disabilities include users having problems related to memory, problem-solving, attention, visual comprehension etc. Challenges faced by people having cognitive disabilities include, getting distracted by scrolling text, blinking icons or multiple pop-ups on a webpage, inability of people having visual comprehension difficulties in correlating photograph of a person with representation of the person, inability of a person with problem solving difficulties in navigating webpages with bad links, etc. The accessibility challenges get intensified for web applications with interactive information sharing such as Web 2.0 applications because for such applications, users tend to be content producers and may not be able to produce accessible content.

Efforts have been made to make websites more accessible to persons with disabilities or special needs. For example, U.S. Patent Application Publication No. 20100131797, published May 27, 2010, entitled “METHOD AND SYSTEM FOR ASSESSING AND REMEDYING ACCESSIBILITY OF WEBSITES,” which is hereby incorporated by reference in its entirety, discloses a system and method for assessing and remedying accessibility of websites. The method includes receiving a website address for assessment, an accessibility guideline and level of assessment to be performed from the user. The method further includes crawling the website for extracting information. The information comprises HTML tags used in designing a webpage. Thereafter, the website is scanned for checking conformance to one or more accessibility parameters. Finally, one or more assessment reports are provided to the user.

In addition, efforts have been made to assess the accessibility of websites to persons with disabilities or special needs. For example, U.S. Patent Application Publication No. 20100268809, published Oct. 21, 2010, entitled “SYSTEM AND METHOD FOR ASSESSING THE USABILITY AND ACCESSIBILITY OF WEB 2.0 FEATURES AND FUNCTIONALITIES OF WEBSITES,” which is also hereby incorporated by reference in its entirety, discloses a system and method for accessing the usability and accessibility of a website includes generating a checklist of accommodations corresponding to an accessibility metric of the website, selecting one or more profiles of the website, and selecting Web 2.0 features of the website. The method may further include investigating tradeoffs of accommodations of different sets of Web 2.0 features and determining one or more accommodations necessary for a particular group of users.

Given the clear benefits of websites being accessible by people of different abilities or by people having disabilities, there exists a need to determine the accessibility of websites and provide users with that information in a useful manner.

### SUMMARY

The disclosed embodiment relates to a system and method for rating the accessibility of websites to disabled users. The method comprises receiving, with a computing device, ratings information from at least one user, the ratings information including ratings values of at least one website based on at least one web accessibility parameter, the web accessibility parameters including at least one of a content index parameter, a comprehension index parameter, a presentation index parameter, a navigation index parameter, a structure index parameter, a user controls index parameter, and a technology alternatives index parameter, determining, with a computing device, a web accessibility score for at least one of the websites, wherein the web accessibility score is based on the ratings information received from the at least one user, and creating, with a computing device, a web accessibility index including the web accessibility score of at least one of the websites based on the determined web accessibility score.

The disclosed embodiment further relates to a system for rating the accessibility of websites to disabled users. The system comprises a computing device configured to receive ratings information from at least one user, the ratings information including ratings values of at least one website based on at least one web accessibility parameter, the web accessibility parameters including at least one of a content index parameter, a comprehension index parameter, a presentation index parameter, a navigation index parameter, a structure index parameter, a user controls index parameter, and a technology alternatives index parameter, a computing device configured to determine a web accessibility score for at least one of the websites, wherein the web accessibility score is based on the ratings information received from the at least one user, and a computing device configured to create a web accessibility index including the web accessibility score of at least one of the websites based on the determined web accessibility score.

The disclosed embodiment further relates to computer-readable code stored on a computer-readable medium that, when executed by a processor, performs a method for rating the accessibility of websites to disabled users. The method comprises receiving, with a computing device, ratings information from at least one user, the ratings information including ratings values of at least one website based on at least one web accessibility parameter, the web accessibility parameters including at least one of a content index parameter, a comprehension index parameter, a presentation index parameter, a navigation index parameter, a structure index parameter, a user controls index parameter, and a technology alternatives index parameter, determining, with a computing device, a web accessibility score for at least one of the websites, wherein the web accessibility score is based on the ratings information received from the at least one user, and creating, with a computing device, a web accessibility index including the web accessibility score of at least one of the websites based on the determined web accessibility score.

As described herein, the web accessibility parameter preferably relates to the accessibility of the website to a user having a disability. In addition, the ratings values are preferably based on whether none of the website functionalities are accessible, some of the website functionalities are accessible, and all of the website functionalities are accessible. Moreover, the web accessibility index may includes web accessibility scores from other websites, and the web accessibility index may be presented on a user interface.

### BRIEF DESCRIPTION OF THE DRAWINGS

FIG. 1 illustrates an overview of an exemplary system according to the disclosed embodiment.

FIG. 2 is a flowchart illustrating an exemplary method according to the disclosed embodiment.

FIG. 3 illustrates an exemplary computing device useful for implementing systems and performing methods disclosed herein.

### DETAILED DESCRIPTION

The disclosed embodiment relates to a new system and method for creating a Web Accessibility Index in online scenarios. This is very useful for enterprises having an online presence to understand their Web Accessibility Index score and plan their Web Accessibility strategies accordingly. The Web Accessibility Index preferably measures the accessibility of websites for users with the following disabilities: blind users of screen readers, deaf or hard of hearing users, low-vision users and/or users of screen magnifiers, colorblind users, users with a motor disability and users with cognitive disabilities, and the like. The Web Accessibility Index captures rankings on various Web Accessibility parameters classified under Content (Audio, Graphics/Video), Comprehension, Presentation (Text, Colour, Tables, Language), Navigation, Structure (Site Structure, Links, Forms, Semantic Data, Help), User Controls (Time Limits, Updates, Focus), Technology Alternatives (Frames, Javascript, CSS, Others), on a 3 point scale (0—none of the functionalities are accessible, 1—some of the functionalities are accessible, 2—all the functionalities are accessible). The Composite Index, which is an aggregation of the scores assigned to the multitude of parameters is the Web Accessibility Index for online scenarios. The purpose of the system and method is to provide a mechanism by which enterprises can assign ranks to their Web Accessibility initiatives as well as compare their Web Accessibility Index against their peer group.

In addition to online scenarios, the disclosed embodiments can be implemented on any enterprises having an online presence, for example, in banking, insurance, and the like. These enterprises can even use the disclosed embodiments to self assess their Web Accessibility Index based on various parameters and benchmark themselves against the index ratings of their competitors.

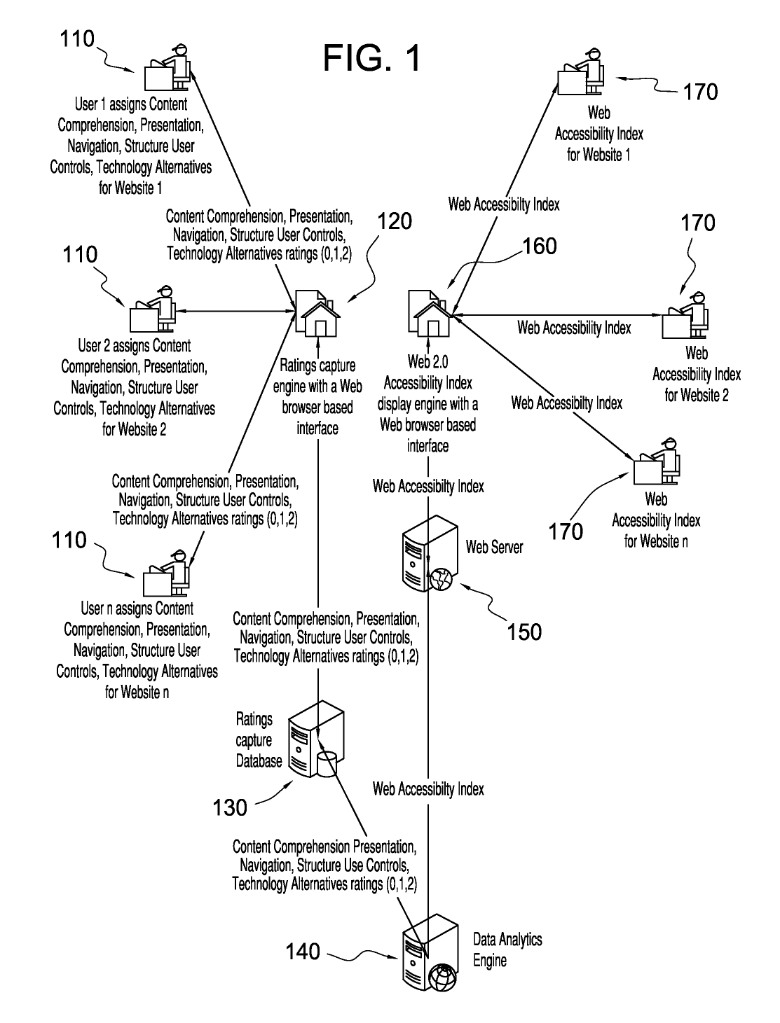

FIG. 1 illustrates an overview of an exemplary system according to the disclosed embodiment. As shown in FIG. 1, users 110 view websites and rate the websites based on a variety of accessibility parameters including, for example, a Content Index parameter (which captures the Content Index constituents from a web accessibility perspective), a Comprehension Index parameter (which captures the Comprehension Index constituents from a web accessibility perspective), a Presentation Index parameter (which captures the Presentation Index constituents from a web accessibility perspective), a Navigation Index parameter (which captures the Navigation Index constituents from a web accessibility perspective), a Structure Index parameter (which captures the Structure Index constituents from a web accessibility perspective), a User Controls Index parameter (which captures the User Controls Index constituents from a web accessibility perspective), and a Technology Alternatives Index parameter (which captures the Technology Alternatives Index constituents from a web accessibility perspective).

While any rating system may be used, the accessibility parameters are preferably rated on a numerical scale, for example:
0—None of the functionalities are accessible
1—Some of the functionalities are accessible
2—All of the functionalities are accessible.

The ratings submitted by users 110 are collected or received by a user interface 120, such as a Web based browser user interface, and routed to database 130, such as a ratings capture database. Processor 140, such as a data analytics engine, analyzes the user ratings and develops or creates a Web Accessibility Index based on the ratings, on the accessibility parameters. The Web Accessibility Index preferable includes weightings assigned by a multitude of users, thereby providing a comprehensive aggregate rating of each website's accessibility. In addition to developing the Web Accessibility Index, processor 140 can also benchmark the Web Accessibility Index created for one online retailer with that of the peer group of online retailers, create or implement tools for providing users with an initial understanding of current Web Accessibility initiatives, benchmark the same against a peer group, and plan the future course of action, and the like.

After the Web Accessibility Index is created, it is sent to web server 150, and displayed to users 170 via an interface 160, such as a Web 2.0 accessibility index display engine with a Web browser based interface. Interface 160 can also be used to display the results of any benchmarking Users 170 can then use the information contained in the Web Accessibility Index to review and select websites based on their accessibility ratings. This service may be offered to users 170 as part of an Internet service, for example.

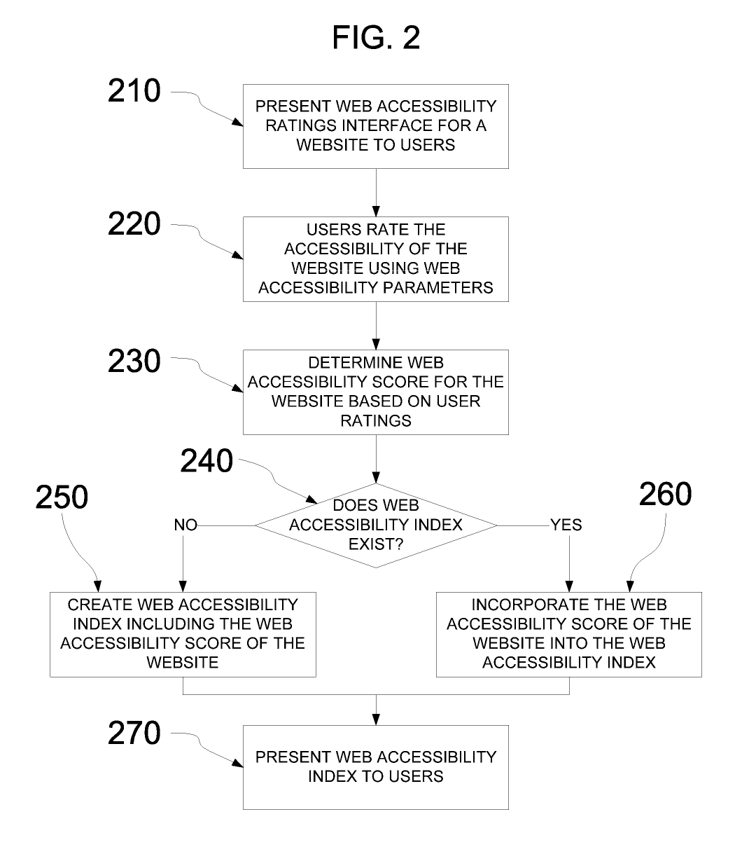

FIG. 2 is a flowchart of an exemplary method according to the disclosed embodiment. in step 210, user are presented with a web accessibility ratings interface for one or more websites. This interface enables a user to rate the website's accessibility using the above described accessibility parameters, including, for example, the Content Index parameter, the Comprehension Index parameter, the Presentation Index parameter, the Navigation Index parameter, the Structure Index parameter, a User Controls Index parameter, and the Technology Alternatives Index parameter. In step 220, the users rate the accessibility of the website using the web accessibility parameters displayed on the interface. When the user is finished rating the website, a web accessibility score is determined for the website based on user ratings in step 230. The web accessibility score is an aggregate score based on the ratings information received from the users. In step 240, a determination is made regarding whether or not a web accessibility index already exists for the website or its peers. If no web accessibility index exists, a new web accessibility index is created in step 250. The web accessibility index should include the web accessibility score of the website. If a web accessibility index already exists for the website or its peers, the web accessibility score of the website is incorporated into the existing web accessibility index in step 160. The web accessibility can then be presented to the same or different users in step 270.

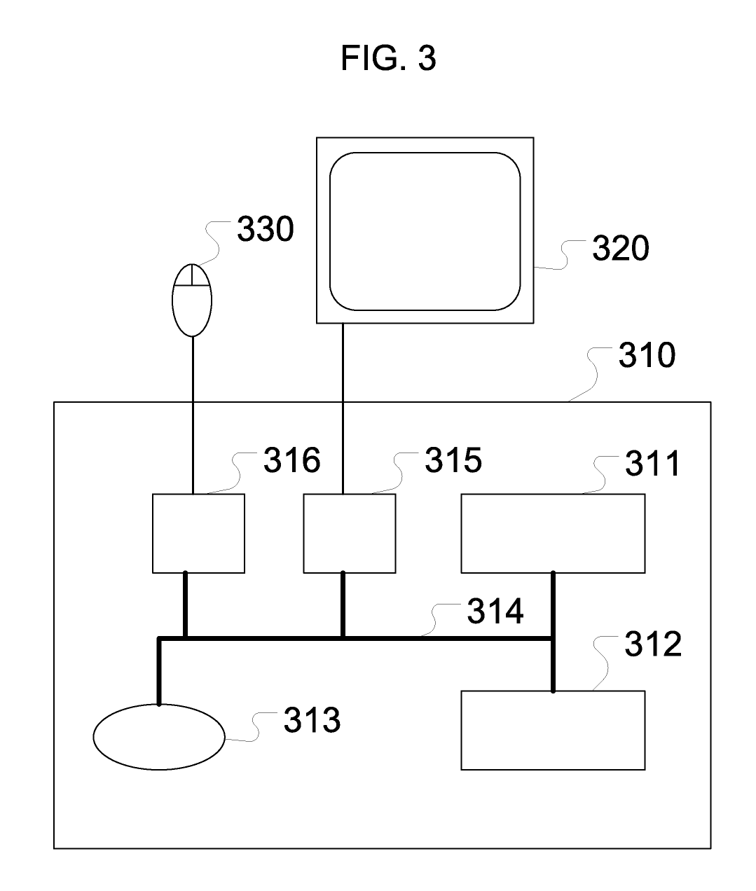

These embodiments may be implemented with any suitable hardware and/or software configuration, including, for example, modules executed on computing devices such as computing device 310 of FIG. 3. Embodiments may, for example, execute modules corresponding to steps shown in the methods described herein. Of course, a single step may be performed by more than one module, a single module may perform more than one step, or any other logical division of steps of the methods described herein may be used to implement the processes as software executed on a computing device.

Computing device 310 has one or more processing device 311 designed to process instructions, for example computer readable instructions (i.e., code) stored on a storage device 313. By processing instructions, processing device 311 may perform the steps set forth in the methods described herein. Storage device 313 may be any type of storage device (e.g., an optical storage device, a magnetic storage device, a solid state storage device, etc.), for example a non-transitory storage device. Alternatively, instructions may be stored in remote storage devices, for example storage devices accessed over a network or the internet. Computing device 310 additionally has memory 312, an input controller 316, and an output controller 315. A bus 314 operatively couples components of computing device 310, including processor 311, memory 312, storage device 313, input controller 316, output controller 315, and any other devices (e.g., network controllers, sound controllers, etc.). Output controller 315 may be operatively coupled (e.g., via a wired or wireless connection) to a display device 320 (e.g., a monitor, television, mobile device screen, touch-display, etc.) in such a fashion that output controller 315 can transform the display on display device 320 (e.g., in response to modules executed). Input controller 316 may be operatively coupled (e.g., via a wired or wireless connection) to input device 330 (e.g., mouse, keyboard, touch-pad, scroll-ball, touch-display, etc.) in such a fashion that input can be received from a user (e.g., a user may input with an input device 330 a dig ticket).

Of course, FIG. 3 illustrates computing device 310, display device 320, and input device 330 as separate devices for ease of identification only. Computing device 310, display device 320, and input device 330 may be separate devices (e.g., a personal computer connected by wires to a monitor and mouse), may be integrated in a single device (e.g., a mobile device with a touch-display, such as a smartphone or a tablet), or any combination of devices (e.g., a computing device operatively coupled to a touch-screen display device, a plurality of computing devices attached to a single display device and input device, etc.). Computing device 310 may be one or more servers, for example a farm of networked servers, a clustered server environment, or a cloud network of computing devices.

While systems and methods are described herein by way of example and embodiments, those skilled in the art recognize that the systems and methods for identifying telecom users based on call usage patterns are not limited to the embodiments or drawings described. It should be understood that the drawings and description are not intended to be limiting to the particular form disclosed. Rather, the intention is to cover all modifications, equivalents and alternatives falling within the spirit and scope of the appended claims. Any headings used herein are for organizational purposes only and are not meant to limit the scope of the description or the claims. As used herein, the word “may” is used in a permissive sense (i.e., meaning having the potential to), rather than the mandatory sense (i.e., meaning must). Similarly, the words “include”, “including”, and “includes” mean including, but not limited to.

Various embodiments of the disclosed embodiment have been disclosed herein. However, various modifications can be made without departing from the scope of the embodiments as defined by the appended claims and legal equivalents.

What is claimed is:

1. A method for rating the accessibility of websites to disabled users, the method comprising:
receiving, with a computing device, ratings information from at least one user, the ratings information including ratings values of at least one website based on at least one web accessibility parameter, the web accessibility parameters including at least one of a content index parameter, a comprehension index parameter, a presentation index parameter, a navigation index parameter, a structure index parameter, a user controls index parameter, and a technology alternatives index parameter;
determining, with a computing device, a web accessibility score for at least one of the websites, wherein the web accessibility score is based on the ratings information received from the at least one user; and
creating, with a computing device, a web accessibility index including the web accessibility score of at least one of the websites based on the determined web accessibility score.

2. The method of claim 1, wherein the web accessibility parameter relates to the accessibility of the website to a user having a disability.

3. The method of claim 1, wherein the ratings values are based on whether none of the website functionalities are accessible, some of the website functionalities are accessible, and all of the website functionalities are accessible.

4. The method of claim 1, wherein the web accessibility index further includes web accessibility scores from other websites.

5. The method of claim 1, further comprising presenting the web accessibility index on a user interface.

6. A system for rating the accessibility of websites to disabled users, the system comprising:
a computing device configured to receive ratings information from at least one user, the ratings information including ratings values of at least one website based on at least one web accessibility parameter, the web accessibility parameters including at least one of a content index parameter, a comprehension index parameter, a presentation index parameter, a navigation index parameter, a structure index parameter, a user controls index parameter, and a technology alternatives index parameter;
a computing device configured to determine a web accessibility score for at least one of the websites, wherein the web accessibility score is based on the ratings information received from the at least one user; and
a computing device configured to create a web accessibility index including the web accessibility score of at least one of the websites based on the determined web accessibility score.

7. The system of claim 6, wherein the web accessibility parameter relates to the accessibility of the website to a user having a disability.

8. The system of claim 6, wherein the ratings values are based on whether none of the website functionalities are accessible, some of the website functionalities are accessible, and all of the website functionalities are accessible.

9. The system of claim 6, wherein the web accessibility index further includes web accessibility scores from other websites.

10. The system of claim 6, further comprising a computing device configured to present the web accessibility index on a user interface.

11. Computer-readable code stored on a computer-readable medium that, when executed by a processor, performs a method for rating the accessibility of websites to disabled users, the method comprising:
receiving, with a computing device, ratings information from at least one user, the ratings information including ratings values of at least one website based on at least one web accessibility parameter, the web accessibility parameters including at least one of a content index parameter, a comprehension index parameter, a presentation index parameter, a navigation index parameter, a structure index parameter, a user controls index parameter, and a technology alternatives index parameter;
determining, with a computing device, a web accessibility score for at least one of the websites, wherein the web accessibility score is based on the ratings information received from the at least one user; and
creating, with a computing device, a web accessibility index including the web accessibility score of at least one of the websites based on the determined web accessibility score.

12. The method of claim 11, wherein the web accessibility parameter relates to the accessibility of the website to a user having a disability.

13. The method of claim 11, wherein the ratings values are based on whether none of the website functionalities are accessible, some of the website functionalities are accessible, and all of the website functionalities are accessible.

14. The method of claim 11, wherein the web accessibility index further includes web accessibility scores from other websites.

15. The method of claim 11, further comprising presenting the web accessibility index on a user interface.
